(19) United States
(12) Patent Application Publication
(10) Pub. No.: US 2024/0205003 A1
(43) Pub. Date: Jun. 20, 2024

(54) SYSTEMS AND METHODS FOR KEY SYNCHRONIZATION IN MULTI-CLOUD ENVIRONMENTS

(71) Applicant: JPMORGAN CHASE BANK, N.A., New York, NY (US)

(72) Inventors: Reetu BOK, Philadelphia, PA (US); Dipti AHUJA, Basking Ridge, NJ (US); Bipin MORE, Edison, NJ (US); Neeraj TATI, Fremont, CA (US); Valanka FERNANDES, Edison, NJ (US)

(21) Appl. No.: 18/066,010

(22) Filed: Dec. 14, 2022

(51) Int. Cl. H04L 9/08; H04L 9/30

(52) U.S. Cl. CPC H04L 9/0894; H04L 9/3073

(57) ABSTRACT

Systems and methods for key synchronization in multi-cloud environments are disclosed. A method may include: (1) generating, by a synching computer application and using a first key management service in a first cloud environment, a data encryption key and storing the data encryption key in the first key management service; (2) generating, by the synching computer application and using a second key management service in a second cloud environment, a key encryption key pair comprising a private key and a public key and storing the key encryption key pair in the second key management service; (3) fetching, by the synching computer application, the public key from the second key management service; (4) encrypting, by the synching computer application, the data encryption key with the public key; and (5) storing, by the synching computer application, the encrypted data encryption key in a database in the second cloud environment.

### BACKGROUND OF THE INVENTION

### 1. Field of the Invention

Embodiments generally relate to systems and methods for key synchronization in multi-cloud environments.

### 2. Description of the Related Art

Large enterprises are often set up to run applications in multiple environments, including on-premises and in multi-cloud environments. With applications comes application data, including sensitive data that needs protected by encryption keys and/or signing keys. For resiliency and latency reasons, the enterprise may decide to keep the encryption and signing keys on every cloud environment. For example, on Amazon Web Services (AWS), an enterprise may use AWS Key Management Service to store their encryption and signing keys, whereas on-premises systems may have their own proprietary key management solution. Key management services, however, may be incapable of exchanging keys with each other directly and some key management service restrict import of externally generated key.

### SUMMARY OF THE INVENTION

Systems and methods for key synchronization in multi-cloud environments are disclosed. In one embodiment, a method for key synchronization in multi-cloud environments may include: (1) generating, by a synching computer application and using a first key management service in a first cloud environment, a data encryption key and storing the data encryption key in the first key management service; (2) generating, by the synching computer application and using a second key management service in a second cloud environment, a key encryption key pair comprising a private key and a public key and storing the key encryption key pair in the second key management service; (3) fetching, by the synching computer application, the public key from the second key management service; (4) encrypting, by the synching computer application, the data encryption key with the public key; and (5) storing, by the synching computer application, the encrypted data encryption key in a database in the second cloud environment.

In one embodiment, the synching computer application generates and stores the data encryption key in the first key management service via a first key management service application programming interface endpoint in the first cloud environment.

In one embodiment, the synching computer application generates and stores the key encryption key pair in the second key management service via a second key management service application programming interface endpoint in the second cloud environment.

In one embodiment, the synching computer application stores the encrypted data encryption key in the database in the second cloud environment via a database application programming endpoint in the second cloud environment.

In one embodiment, the method may also include: receiving, by an application instance in the second cloud environment, encrypted data that is encrypted with the data encryption key; retrieving, by the application instance and from the database, the encrypted data encryption key; retrieving, by the application instance and from the second key management service, the private key; decrypting, by the application instance, the encrypted data encryption key with the private key; and decrypting, by the application instance, the encrypted data using the data encryption key.

In one embodiment, the method may also include receiving, by an application instance in the second cloud environment, encrypted data that is encrypted with the data encryption key; retrieving, by the application instance and from the database, the encrypted data encryption key; sending, by the application instance, the encrypted data encryption key to the second key management service, wherein the second key management service is configured to decrypt the encrypted data encryption key with the private key; receiving, by the application instance and from the second key management service, the data encryption key; and decrypting, by the application instance, the encrypted data using the data encryption key.

According to another embodiment, a system may include a first cloud environment comprising a synching computer application and a first key management service and a second cloud environment comprising a second key management service and a database. The synching computer application generates, using the first key management service a data encryption key and stores the data encryption key in the first key management service, generates, using the second key management service, a key encryption key pair comprising a private key and a public key and storing the key encryption key pair in the second key management service, fetches the public key from the second key management service, encrypts the data encryption key with the public key, and stores the encrypted data encryption key in a database in the second cloud environment.

In one embodiment, the first cloud environment also includes a first key management service application programming interface endpoint, and the synching computer application generates and stores the data encryption key in the first key management service via the first key management service application programming interface endpoint.

In one embodiment, the second cloud environment also includes a second key management service application programming interface endpoint, and the synching computer application generates and stores the key encryption key pair in the second key management service via the second key management service application programming interface endpoint.

In one embodiment, the second cloud environment also includes a database application programming endpoint, and the synching computer application stores the encrypted data encryption key in the database in the second cloud environment via the database application programming endpoint.

In one embodiment, the second cloud environment also includes an application instance, and the application instance receives encrypted data that is encrypted with the data encryption key, retrieves the encrypted data encryption key from the database, retrieves the private key from the second key management service, decrypts the encrypted data encryption key with the private key, and decrypts the encrypted data using the data encryption key.

In one embodiment, the second cloud environment also includes an application instance, and the application instance receives encrypted data that is encrypted with the data encryption key, retrieves the encrypted data encryption key from the database, sends the encrypted data encryption key to the second key management service, receives data encryption key from the second key management service, and decrypts the encrypted data using the data encryption key.

According to another embodiment, a non-transitory computer readable storage medium includes instructions stored thereon, which when read and executed by one or more computer processors, cause the one or more computer processors to perform steps comprising: generating, using a first key management service in a first cloud environment, a data encryption key and storing the data encryption key in the first key management service; generating, using a second key management service in a second cloud environment, a key encryption key pair comprising a private key and a public key and storing the key encryption key pair in the second key management service; fetching the public key from the second key management service; encrypting the data encryption key with the public key; and storing the encrypted data encryption key in a database in the second cloud environment.

In one embodiment, the data encryption key is generated and stored in the first key management service via a first key management service application programming interface endpoint in the first cloud environment.

In one embodiment, the key encryption key pair is generated and stored in the second key management service via a second key management service application programming interface endpoint in the second cloud environment.

In one embodiment, the encrypted data encryption key is stored in the database in the second cloud environment via a database application programming endpoint in the second cloud environment.

In one embodiment, the non-transitory computer readable storage medium may also include instructions stored thereon, which when read and executed by one or more computer processors, cause the one or more computer processors to perform steps comprising: receiving encrypted data that is encrypted with the data encryption key; retrieving, from the database, the encrypted data encryption key; retrieving, from the second key management service, the private key; decrypting the encrypted data encryption key with the private key; and decrypting the encrypted data using the data encryption key.

In one embodiment, the non-transitory computer readable storage medium may also include instructions stored thereon, which when read and executed by one or more computer processors, cause the one or more computer processors to perform steps comprising: receiving encrypted data that is encrypted with the data encryption key; retrieving, from the database, the encrypted data encryption key; sending the encrypted data encryption key to the second key management service; receiving, from the second key management service, the data encryption key; and decrypting the encrypted data using the data encryption key.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for key synchronization in multi-cloud environments according to an embodiment.

FIG. 2 depicts a method for key synchronization in multi-cloud environments according to one embodiment.

FIG. 3 depicts a method for decrypting data using key synchronization in multi-cloud environments according to one embodiment.

FIG. 4 depicts an exemplary computing system for implementing aspects of the present disclosure.

### DETAILED DESCRIPTION OF PREFERRED EMBODIMENTS

Embodiments are directed to systems and methods for key synchronization in multi-cloud environments. In embodiments, a Key Management Service (KMS) in each cloud environment may generate a Key Encryption Key (KEK) for its cloud environment. The KEKs are responsible for protecting/encrypting Data Encryption Keys (DEKs). The DEKs are responsible for protecting sensitive data by encrypting or signing. DEKs may be generated in one cloud environment and securely copied to other cloud environment over, for example, HTTP Rest API calls. Encrypted DEKs may be stored in local databases in the cloud environments.

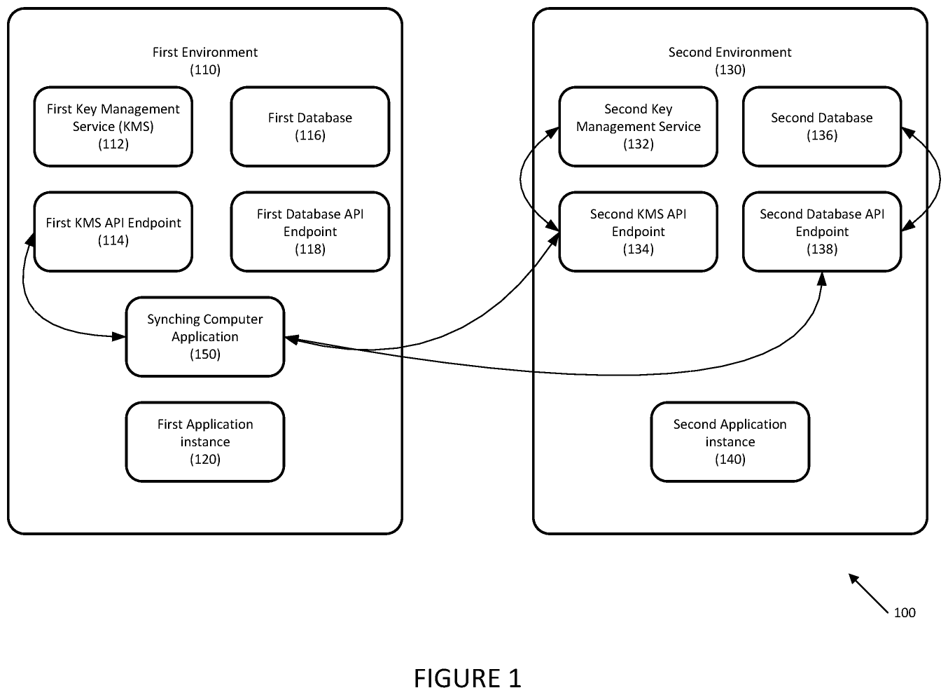

Referring to FIG. 1, a system for key synchronization in multi-cloud environments is disclosed according to an embodiment. System 100 may include cloud environments 110 and 130. Although FIG. 1 depicts two cloud environments, it should be recognized that additional cloud environments may be provided.

Cloud environments 110 and 130 may be on-premises cloud environments, third-party cloud environments, local storage, etc.

Each cloud environment 110 and 130 may include key management services (e.g., first key management service 112, second key management service 132), KMS API endpoints (e.g., first KMS API endpoint 114, second KMS API endpoint 134), databases (e.g., first database 116, second database 136), and API endpoints (e.g., first database API endpoint 118, second database API endpoint 138). Either first environment 110 or second environment 130 may include synching computer application (app) 150, which may synchronize certain keys in first environment 110 and second environment 130. In FIG. 1, synching computer application 150 is depicted as executed in first environment 110, but it could be executed in second environment 130.

First KMS API endpoint 114 and second KMS API endpoint 134 may provide an API for first KMS 112 and second KMS 132, respectively.

First database API endpoint 118 and second database API endpoint 138 may provide an API for first database 116 and second database 136, respectively.

First application instance 120 and second application instance 140 may be provided in first environment 110 and second environment 130, respectively. Application instances 120, 140 may receive request from requesting applications (not shown) to, for example, encrypt data with a DEK or decrypt data with a DEK from one of environments 110 or 130.

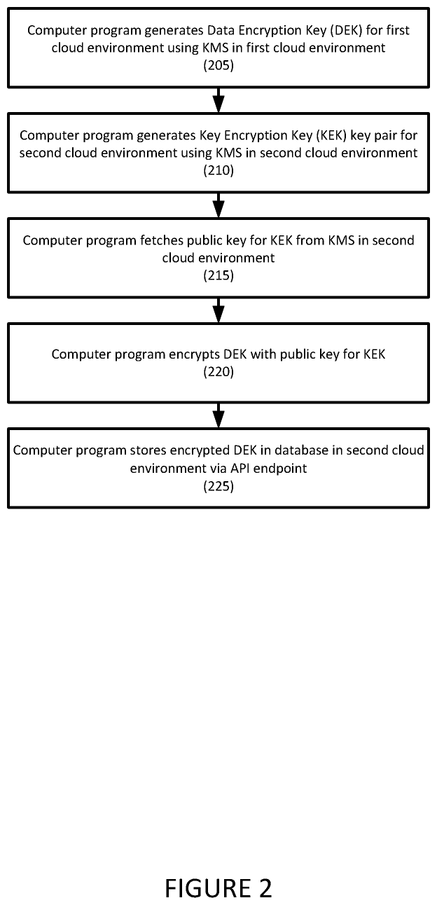

Referring to FIG. 2, a method for key synchronization in multi-cloud environments is disclosed according to an embodiment.
In step 205, a computer program, such as a synching computer application, executed by a first cloud environment may generate a Data Encryption Key (DEK) using a key management service in the first cloud environment (e.g., KMS1). The DEK may be an encryption key (symmetric) or signing key (asymmetric). The DEK may be stored in the KMS in the first cloud environment via an API endpoint, such as KMS1 API endpoint.
In step 210, the computer program may generate a Key Encryption Key (e.g., KEK) pair for a second cloud environment using a KMS in the second cloud environment (e.g., KMS2). The KEK may have a KEK identifier (e.g., keyID: 2). The KEK may be an asymmetric keypair and its public key may be accessed via an endpoint, such as KMS2 API endpoint.
In step 215, the computer program, which exists in first cloud environment, may then fetch the public key for the KEK from the KMS in the second cloud environment.
In step 220, the computer program may encrypt the DEK with the public KEK, and in step 225, may store the encrypted DEK in a database in the second cloud environment via an API endpoint.

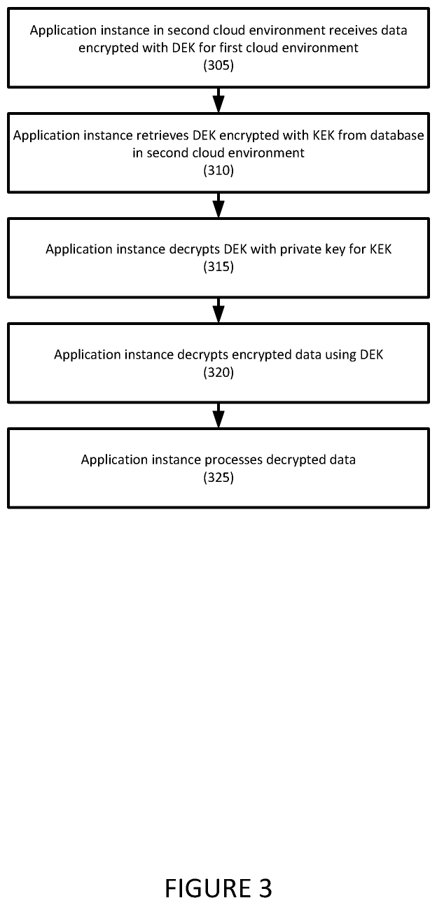

Once stored in the database, when an application instance in the second cloud environment needs to access the DEK, the application instance may fetch the DEK that is encrypted with the KEK, and may decrypt the DEK with the private KEK. For example, referring to FIG. 3, a method for decrypting data using key synchronization in multi-cloud environments according to one embodiment.
In step 305, an application instance in the second cloud environment may receive data encrypted that is encrypted with the DEK for the first cloud environment. The encrypted data may be received from a requesting application.
In step 310, the application instance may retrieve the DEK encrypted with KEK from the database in second cloud environment via the API endpoint.
In step 315, the application instance may decrypt the DEK with the private key for the KEK. In one embodiment, the application instance may retrieve the private key to decrypt the DEK. In another embodiment, the application instance may send the encrypted DEK to the KMS for the second cloud environment, which may decrypt the DEK and return the decrypted DEK to the application instance.
In step 320, the application instance may decrypt the encrypted data using the DEK.
In step 325, the application instance may process or return the decrypted data to the requesting application.

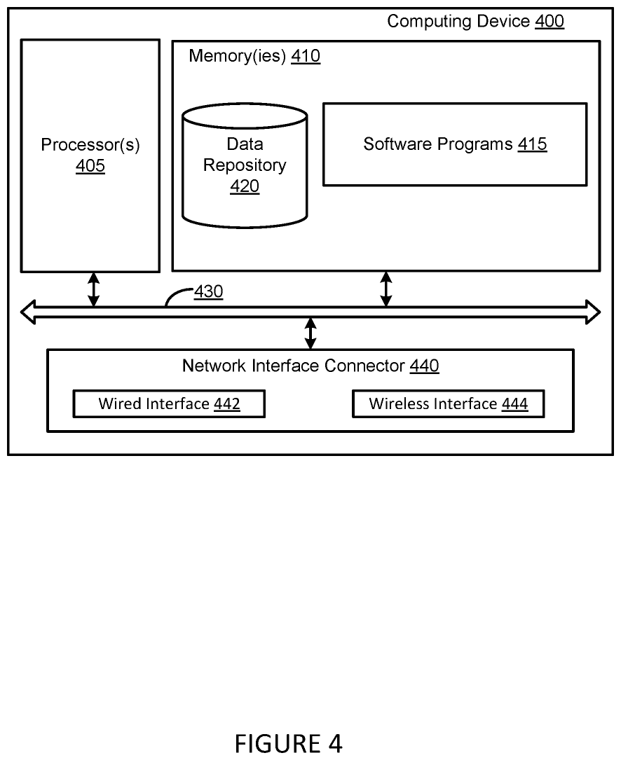

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for key synchronization in multi-cloud environments, comprising:
generating, by a synching computer application and using a first key management service in a first cloud environment, a data encryption key and storing the data encryption key in the first key management service;
generating, by the synching computer application and using a second key management service in a second cloud environment, a key encryption key pair comprising a private key and a public key and storing the key encryption key pair in the second key management service;
fetching, by the synching computer application, the public key from the second key management service;
encrypting, by the synching computer application, the data encryption key with the public key; and
storing, by the synching computer application, the encrypted data encryption key in a database in the second cloud environment.

2. The method of claim 1, wherein the synching computer application generates and stores the data encryption key in the first key management service via a first key management service application programming interface endpoint in the first cloud environment.

3. The method of claim 1, wherein the synching computer application generates and stores the key encryption key pair in the second key management service via a second key management service application programming interface endpoint in the second cloud environment.

4. The method of claim 1, wherein the synching computer application stores the encrypted data encryption key in the database in the second cloud environment via a database application programming endpoint in the second cloud environment.

5. The method of claim 1, further comprising:
receiving, by an application instance in the second cloud environment, encrypted data that is encrypted with the data encryption key;
retrieving, by the application instance and from the database, the encrypted data encryption key;
retrieving, by the application instance and from the second key management service, the private key;
decrypting, by the application instance, the encrypted data encryption key with the private key; and
decrypting, by the application instance, the encrypted data using the data encryption key.

6. The method of claim 1, further comprising:
receiving, by an application instance in the second cloud environment, encrypted data that is encrypted with the data encryption key;
retrieving, by the application instance and from the database, the encrypted data encryption key;
sending, by the application instance, the encrypted data encryption key to the second key management service, wherein the second key management service is configured to decrypt the encrypted data encryption key with the private key;
receiving, by the application instance and from the second key management service, the data encryption key; and
decrypting, by the application instance, the encrypted data using the data encryption key.

7. A system, comprising:
a first cloud environment comprising a synching computer application and a first key management service; and
a second cloud environment comprising a second key management service and a database;
wherein:
the synching computer application generates, using the first key management service a data encryption key and stores the data encryption key in the first key management service;
the synching computer application generates, using the second key management service, a key encryption key pair comprising a private key and a public key and storing the key encryption key pair in the second key management service;
the synching computer application fetches the public key from the second key management service;
the synching computer application encrypts the data encryption key with the public key; and
the synching computer application stores the encrypted data encryption key in a database in the second cloud environment.

8. The system of claim 7, wherein the first cloud environment further comprises a first key management service application programming interface endpoint, and the synching computer application generates and stores the data encryption key in the first key management service via the first key management service application programming interface endpoint.

9. The system of claim 7, wherein the second cloud environment further comprises a second key management service application programming interface endpoint, and the synching computer application generates and stores the key encryption key pair in the second key management service via the second key management service application programming interface endpoint.

10. The system of claim 7, wherein the second cloud environment further comprises a database application programming endpoint, and the synching computer application stores the encrypted data encryption key in the database in the second cloud environment via the database application programming endpoint.

11. The system of claim 7, wherein the second cloud environment further comprises an application instance, and the application instance receives encrypted data that is encrypted with the data encryption key, retrieves the encrypted data encryption key from the database, retrieves the private key from the second key management service, decrypts the encrypted data encryption key with the private key, and decrypts the encrypted data using the data encryption key.

12. The system of claim 7, wherein the second cloud environment further comprises an application instance, and the application instance receives encrypted data that is encrypted with the data encryption key, retrieves the encrypted data encryption key from the database, sends the encrypted data encryption key to the second key management service, receives data encryption key from the second key management service, and decrypts the encrypted data using the data encryption key.

13. A non-transitory computer readable storage medium, including instructions stored thereon, which when read and executed by one or more computer processors, cause the one or more computer processors to perform steps comprising:
generating, using a first key management service in a first cloud environment, a data encryption key and storing the data encryption key in the first key management service;
generating, using a second key management service in a second cloud environment, a key encryption key pair comprising a private key and a public key and storing the key encryption key pair in the second key management service;
fetching the public key from the second key management service;
encrypting the data encryption key with the public key; and
storing the encrypted data encryption key in a database in the second cloud environment.

14. The non-transitory computer readable storage medium of claim 13, wherein the data encryption key is generated and stored in the first key management service via a first key management service application programming interface endpoint in the first cloud environment.

15. The non-transitory computer readable storage medium of claim 13, wherein the key encryption key pair is generated and stored in the second key management service via a second key management service application programming interface endpoint in the second cloud environment.

16. The non-transitory computer readable storage medium of claim 13, wherein the encrypted data encryption key is stored in the database in the second cloud environment via a database application programming endpoint in the second cloud environment.

17. The non-transitory computer readable storage medium of claim 13, further including instructions stored thereon, which when read and executed by one or more computer processors, cause the one or more computer processors to perform steps comprising:
receiving encrypted data that is encrypted with the data encryption key;
retrieving, from the database, the encrypted data encryption key;
retrieving, from the second key management service, the private key;
decrypting the encrypted data encryption key with the private key; and
decrypting the encrypted data using the data encryption key.

18. The non-transitory computer readable storage medium of claim 13, further including instructions stored thereon, which when read and executed by one or more computer processors, cause the one or more computer processors to perform steps comprising:
receiving encrypted data that is encrypted with the data encryption key;
retrieving, from the database, the encrypted data encryption key;
sending the encrypted data encryption key to the second key management service;
receiving, from the second key management service, the data encryption key; and
decrypting the encrypted data using the data encryption key.
